(19) United States
(12) Patent Application Publication
(10) Pub. No.: US 2025/0080013 A1
(43) Pub. Date: Mar. 6, 2025

(54) MOBILE INTELLIGENT TERMINAL WITH EMERGENCY CHARGING FUNCTION

(71) Applicant: Dongguan Jinconn New Material Co., Ltd., Dongguan (CN)

(72) Inventors: Liang CHEN, Dongguan (CN); Song CHEN, Dongguan (CN); Xiangyang LIU, Dongguan (CN); Wei LI, Dongguan (CN); Huaping XU, Dongguan (CN); Feiyang LIU, Dongguan (CN)

(73) Assignee: Dongguan Jinconn New Material Co., Ltd., Dongguan (CN)

(21) Appl. No.: 18/485,870

(22) Filed: Oct. 12, 2023

(30) Foreign Application Priority Data
Aug. 28, 2023 (CN) 2023110924325

(51) Int. Cl. H02N 11/00; H01F 7/02; H02J 7/00; H04M 1/02

(52) U.S. Cl. CPC H02N 11/002; H01F 7/02; H02J 7/0042; H04M 1/0262

(57) ABSTRACT

The invention pertains to a mobile intelligent terminal with emergency charging function. The terminal comprises a smartphone and an emergency power generating assembly cooperating with the smartphone; the emergency power generating assembly includes an induction coil and a first magnet reciprocating relative to the induction coil, the first magnet moves relative to the induction coil to cut the magnetic induction lines of the first magnet, the induction coil is used to charge a lithium battery of the smartphone. By shaking the smartphone, the first magnet moves relative to the induction coil, making the induction coil to cut the magnetic induction lines of the first magnet to generate an electromotive force, achieving energy conversion and transmission. By rotating the driving assembly, it is able to generate power for temporary calls or location service when there is no power bank or external power supply, thus the present invention has strong practicality.

### CROSS-REFERENCE TO RELATED APPLICATIONS

The application claims priority to Chinese patent application No. 2023110924325, filed on Aug. 28, 2023, the entire contents of which are incorporated herein by reference.

### TECHNICAL FIELD

The invention pertains to the field of mobile intelligent terminals, particularly to a mobile intelligent terminal with emergency charging function.

### BACKGROUND

Mobile intelligent terminals are devices accessible to the internet and running with various operating systems. It is able to customize various functions according to user needs, including mobile phones. Mobile phones are currently the most popular communication means, almost every person has one in hand. Due to the development, mobile phones are not only communication means, but also used for entertainment, computing, payment, office, and navigation. It plays an increasingly important role in people's lives, the time spend on is also increasing.

Although the battery capacity of the conventional mobile phones is large, it still cannot keep up with the longer usage time of mobile phones. Moreover, since the batteries of existing mobile phones are charged by chargers. Once you forget to charge, communication interruption occurs easily. Although auxiliary power sources such as power banks is also used to replenish power, there are also situations where the auxiliary power supply is out of power, especially when sending a location or making SOS calls during outdoors or getting lost. If the smartphone battery runs out of power at this time, it is unable to charge for emergency. There is a urgent need for a mobile phone that can generate electricity through mechanical energy conversion and human control. It is used for emergency charging when the phone battery is empty.

### SUMMARY

When the mobile phone is out of power outdoors and needs to send a location or make a phone call temporarily, it is unable to generate power and turn on the phone. The purpose of the disclosure is to solve the problems in the prior art and provides a mobile intelligent terminal product with emergency charging function.

In accordance with an aspect of the embodiment, there is provided a mobile intelligent terminal with emergency charging function, comprising: a smartphone; an emergency power generating assembly cooperating with the smartphone; the emergency power generating assembly includes an induction coil and a first magnet, the first magnet reciprocates relative to the induction coil, the first magnet moves relative to the induction coil, making the induction coil to cut the magnetic induction lines of the first magnet, the induction coil is used to charge a lithium battery of the smartphone.

Preferably, the emergency power generating assembly further includes a cylindrical body, two second magnets and a first rod, two second magnets are arranged on the cylindrical body, two first rods are arranged on two ends of the first magnet, a third magnet is arranged at one end of two first rods away from each other, the third magnet is located between two second magnets, the third magnet and one end of two second magnets close to each other have the same magnetic poles; the induction coil is arranged on the cylindrical body and surrounds the first magnet, the first magnet is reciprocally arranged within the cylindrical body.

Preferably, the emergency power generating assembly further includes two second plates arranged on the cylindrical body, two second plates are both located between two third magnets, the second plate is provided with a bored hole penetrating through the second plate, the second plate is provided with a rolling element for rolling, there are at least three rolling elements arranged surrounding the first rod, the first rod and the second plate is movably arranged via the rolling element.

Preferably, the distance between the first magnet and the second plate is larger than the distance between the third magnet and the second magnet.

Preferably, the mobile intelligent terminal further includes a phone shell detachably connected to the smartphone, the emergency power generating assembly is defined on the phone shell, the smartphone is provided with a second charging coil in conjunction with the induction coil, the induction coil is used to charge the lithium battery of the smartphone via the second charging coil.

Preferably, the emergency power generating assembly further includes an outer casing and a first permanent magnet, the outer casing is defined on the smartphone or the phone shell, the first permanent magnet is defined on the outer casing, the induction coil is located in the outer casing, the first magnet reciprocates within the outer casing, the induction coil surrounds the first magnet, the first magnet is provided with a third connecting rod, the third connecting rod is provided with a second permanent magnet at one end near the first permanent magnet, the second permanent magnet and the first permanent magnet have the same magnetic poles at one end close to each other.

Preferably, one end of the first magnet away from the third connecting rod and is provided with a second connecting rod, the second connecting rod protrudes beyond the outer casing to Preferably, the mobile intelligent terminal further includes a driving assembly arranged on the phone shell, the driving assembly includes a cam disc rotatably arranged on the phone shell, the cam disc abuts against one end of the second connecting rod protruding from the outer casing.

Preferably, the driving assembly includes a first plate connecting with the cam disc, the cam disc is located within the phone shell, the first plate is located outside the phone shell.

Preferably, there are a pluralities of the emergency power generating assemblies, the pluralities of the emergency power generating assembly are arranged surrounding the cam disc.

Compared with the prior art, the present invention has the following advantages and beneficial effects.
1. The first magnet moves relative to the induction coil by shaking the smartphone, making the induction coil to cut the magnetic induction lines of the first magnet, generating an electromotive force to achieve energy conversion and transmission. The same function is achieved by rotating the driving assembly, it is able to generate power for temporary calls or location service when there is no power bank or external power supply, thus the present invention has strong practicality.
2. The first magnet is located inside the induction coil, the induction coil cuts the magnetic induction lines by moving it, thereby transmitting the current generated in the circuit to the first charging coil. The first charging coil charges the smartphone via the second charging coil, thus it is convenient for the smartphone to charge with the help of the phone shell.
3. The outer casing and the housing are all made of magnetism shielding materials, such as ferrite or magnetic metal materials. Ferrite is an electromagnetic material with good magnetic conductivity. It is able to absorb and disperse magnetic field lines, thereby blocking the spreading of magnetic fields. Ferrite materials are commonly used for magnetic shielding covers, magnetic absorption materials, etc, minimizing electromagnetic interference on electronic devices and systems, thereby improving the stability of the smartphone.

### BRIEF DESCRIPTION OF DRAWINGS

The present invention will become more fully understood from the detailed description given herein below and the accompanying drawings which are given by way of illustration only, and thus are not limitative of the present invention, and wherein:

FIG. 1 is a schematic view provided by the present disclosure;

FIG. 2 is a plane schematic view of the smartphone provided by the present disclosure;

FIG. 3 is a schematic view of the emergency power generating assembly provided by the present disclosure;

FIG. 4 is a plane schematic view of the emergency power generating assembly provided by the present disclosure;

FIG. 5 is a plane schematic view of the rolling element provided by the present disclosure;

FIG. 6 is an internal schematic view inside the phone shell provided by the present disclosure;

FIG. 7 is a schematic view of the emergency power generating assembly inside the phone shell provided by the present disclosure;

FIG. 8 is a schematic view of the driving assembly provided by the present disclosure;

FIG. 9 is a sectional schematic view of the phone shell provided by the present disclosure;

FIG. 10 is a schematic view of the smartphone provided by the present disclosure;

FIG. 11 is a schematic view of the electric power generating assembly provided by the present disclosure;

FIG. 12 is a schematic view of the housing provided by the present disclosure;

FIG. 13 is a sectional schematic view of the housing provided by the present disclosure;

FIG. 14 is a schematic view of the pressing assembly provided by the present disclosure.

### DETAILED DESCRIPTION OF THE EMBODIMENTS

The invention will be further described below in details with reference to the figures and embodiments.

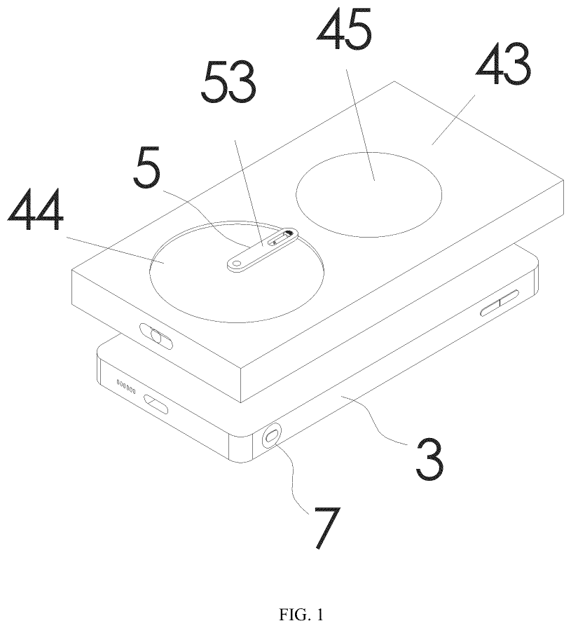

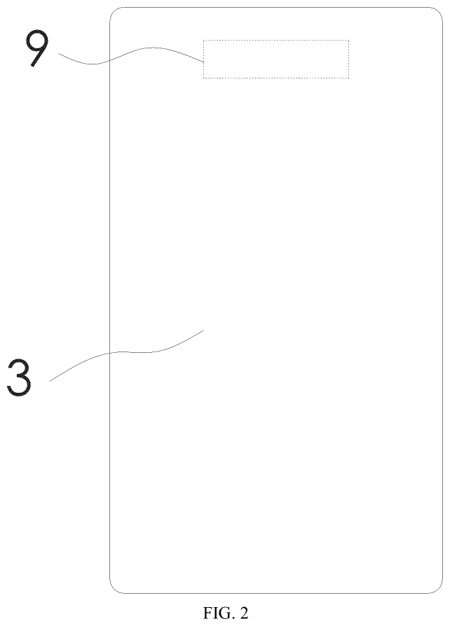

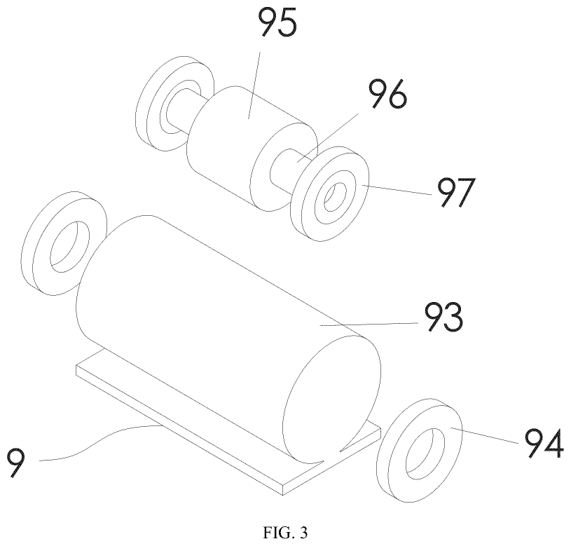

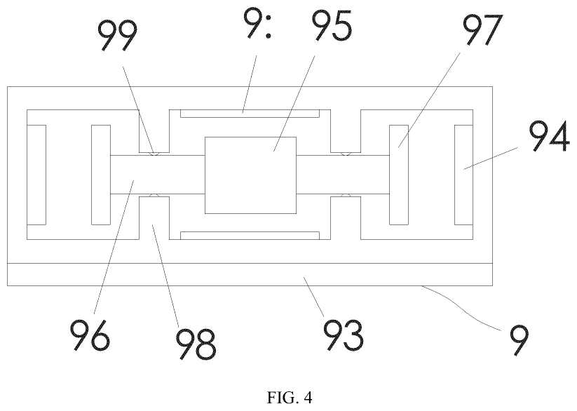

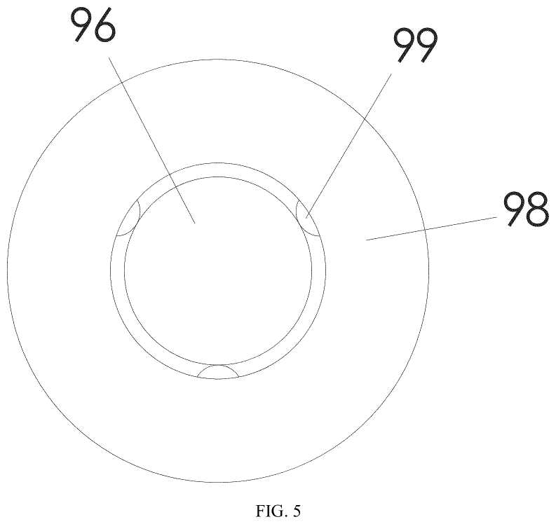

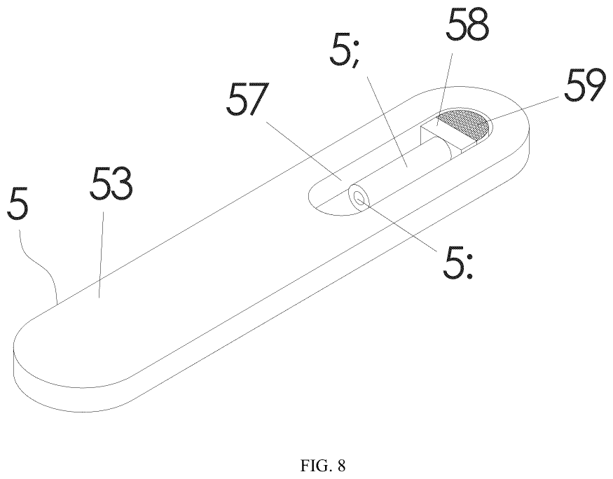

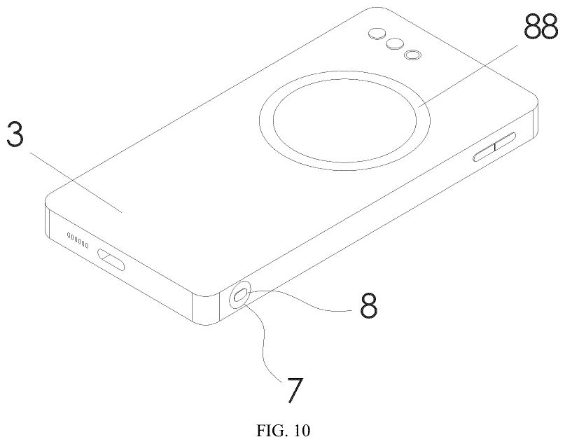

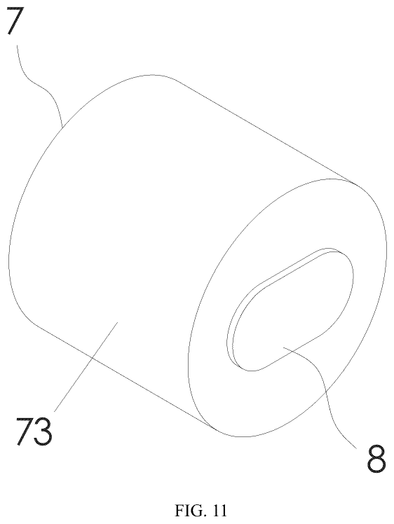

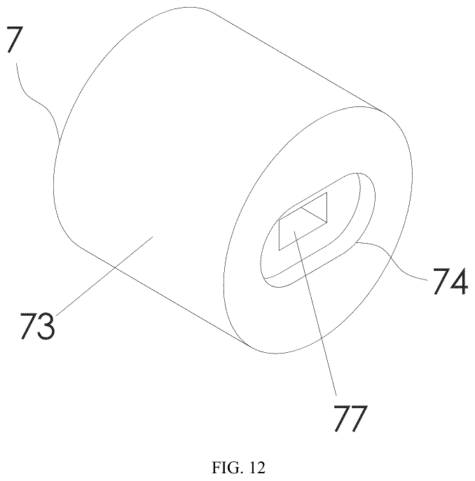

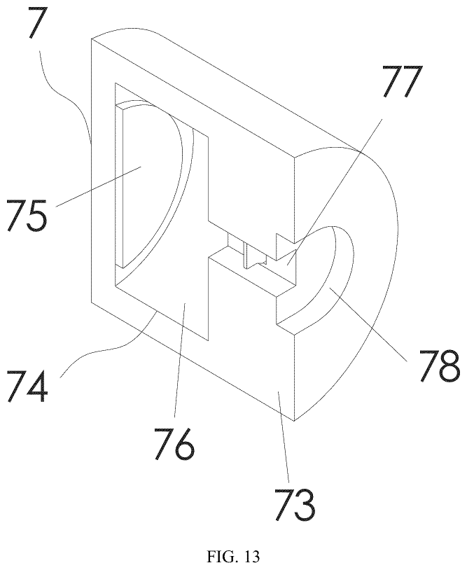

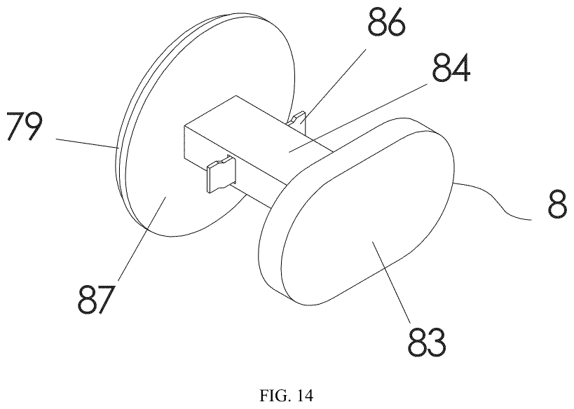

Please refer to FIG. 1 to FIG. 14, the specific structure of a preferred embodiment of the present invention is shown, which is a mobile intelligent terminal with emergency charging function, the mobile intelligent terminal includes a smartphone 1 and an emergency power generating assembly 7 cooperating with the smartphone 1.

The emergency power generating assembly 7 includes an induction coil 78 and a first magnet 73, the first magnet 73 reciprocates relative to the induction coil 78, the first magnet 73 moves relative to the induction coil 78, making the induction coil 78 to cut the magnetic induction lines of the first magnet 73, the induction coil 78 is used to charge a lithium battery of the smartphone 1. The induction coil 78 is coated with a layer of insulation material, such as epoxy resin or phenolic resin, ensuring the using effect of the induction coil 78.

Specifically, the first magnet 73 moves relative to the induction coil 78 by shaking the smartphone 1, making the induction coil 78 to cut the magnetic induction lines of the first magnet 73, generating an electromotive force to achieve energy conversion and transmission. The disclosure is able to generate power for temporary calls or location service when there is no power bank or external power supply, thus the present invention has strong practicality. In this embodiment, the first magnet 73 is a neodymium iron boron magnet, i.e., the first magnet 73 is a powerful magnet.

Specifically, the emergency power generating assembly 7 further includes a cylindrical body 71, two second magnets 72 arranged on the cylindrical body 71, and two first rods 74 arranged on two ends of the first magnet 73, a third magnet 75 is arranged at one end of two first rods 74 away from each other, the third magnet 75 is located between two second magnets 72, the third magnet 75 and one end of two second magnets 72 close to each other have the same magnetic poles; the induction coil 78 is arranged on the cylindrical body 72 and surrounds the first magnet 73, the first magnet 73 is reciprocally arranged within the cylindrical body 71, preventing the end of the first magnet 73 from colliding with the cylindrical body 71 directly during the reciprocating motion and avoiding noise or damage caused by colliding.

Specifically, the emergency power generating assembly 7 further includes two second plates 76 arranged on the cylindrical body 71, two second plates 76 are both located between two third magnets 75, the second plate 76 is provided with a bored hole penetrating through the second plate 76, the second plate 76 is provided with a rolling element 77 for rolling, there are at least three rolling elements 77 arranged surrounding the first rod 74, three rolling elements 77 is alternatively equidistant, as long as the first rod 74 moves stably between three rolling elements 77. The first rod 74 and the second plate 76 is movably arranged via the rolling element 77, thus, the sliding friction between the first rod 74 and the second plate 76 changes to rolling friction, effectively reducing the energy loss and improving the efficiency of the disclosure.

Specifically, the distance between the first magnet 73 and the second plate 76 is larger than the distance between the third magnet 75 and the second magnet 72. The third magnet 75 is relatively fixed with the first magnet 73, the distance between the first magnet 73 and the second plate 76 is still greater than the distance between the third magnet 75 and the second magnet 72, preventing collision damage between the first magnet 73 and the second plate 76 effectively during movement.

Specifically, the mobile intelligent terminal further includes an electric power generating assembly 5 cooperating with the smartphone 1, a pressing assembly 6 matching with the electric power generating element 5. The electric power generating assembly 5 includes a housing 51, a piezoelectric sheet 53 arranged on the housing 51, and an extruded plate 57 moving back and forth relative to the piezoelectric sheet 53, the piezoelectric sheet 53 is used to generate electric current under external force to charge the smartphone 1. The pressing assembly 6 includes a switch button 61 and a springback member 64, the springback member 64 is arranged on the housing 51 and used to store and output energy as power, preparing for the next pressing of the button switch 61.

Specifically, the piezoelectric sheet 53 is made of piezoelectric crystalline materials, such as ceramic or polymer materials. When the piezoelectric sheet 53 is subjected to external forces, the crystalline structure changes slightly. In the absence of electric field, when a force is applied to the piezoelectric sheet in a certain direction, mechanical deformation occurs and polarization occurs inside, then different charges appears on two opposite surfaces. The larger the external force and end area, the more charges will appear. If electrodes are installed on the two surfaces and wires are used to connect them. The changing free charge moves from one polar plate to another, forming an electric current to charge the smartphone 1. It is used for temporary calls and location service when there is no power bank or external power supply.

Specifically, the extruded plate 57 compresses the piezoelectric sheet 53 to generate electricity by pressing the switch button 61. The electric power generating assembly 5 has a small volume and is convenient to use. It effectively solves the problem of generating power for temporary calls or location service when there is no power bank or external power supply, alleviating the crisis of temporary power consumption.

Specifically, the pressing assembly 6 further includes a second sliding plate 65, a connecting rod 62 arranged on the second sliding plate 65, and the button switch 61 arranged on the connecting rod, the springback member 64 is arranged between the connecting rod 62 and the housing 51. There are at least two springback members 64 to ensure a good springback effect, the switch button 61 is designed to fit the shape of the hand for easy pressing.

Specifically, a cavity 52 for accommodating the pressing assembly 6 is defined inside the electric power generating element 5. The cavity 52 includes a first slideway 54 for accommodating the second sliding plate 65, a second slideway 55 for accommodating the connecting rod 62, and a blind groove 56 for accommodating the switch button 61. The pressing assembly 6 slides within the cavity 52 in a direction parallel to the axis of the piezoelectric sheet 53. The cavity 52 limits the pressing assembly 6 better and improves its stability during operation.

Specifically, the mobile intelligent terminal further includes a phone shell 21 detachably connected to the smartphone 1. The phone shell 21 is provided with a first charging coil 23 and the emergency power generating assembly 7. The smartphone 1 is provided with a second charging coil 66 in conjunction with the induction coil 78, the induction coil 78 is used to charge the lithium battery of the smartphone 1 via the first charging coil 23 and the second charging coil 66. A layer of insulation material, such as epoxy resin or phenolic resin, is alternatively applied on the outer side of induction coil 78 to ensure effectiveness.

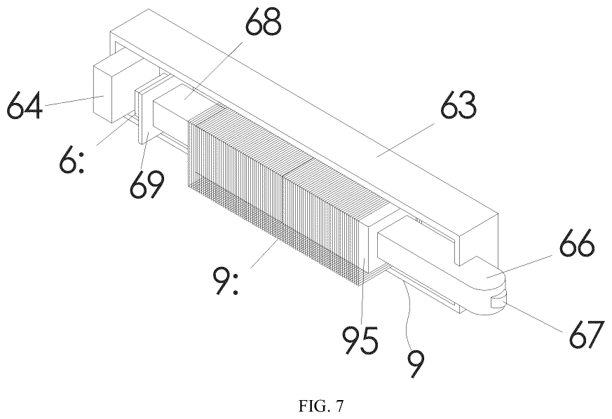

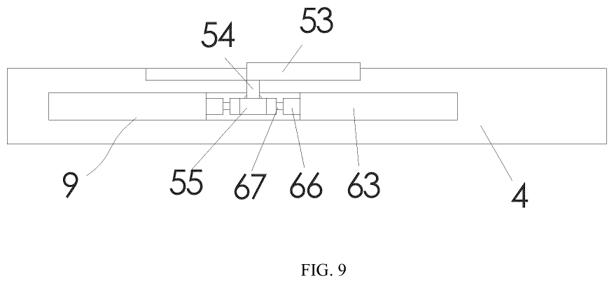

Referring to FIG. 7 and FIG. 9, the emergency power generating assembly 7 further includes an outer casing 41 and a first permanent magnet 42, the outer casing 41 is defined on the phone shell 21, the first permanent magnet 42 is defined on the outer casing 41, the induction coil 78 is located in the outer casing 41, the first magnet 73 reciprocates within the outer casing 41, the induction coil 78 surrounds the first magnet 73, the first magnet 73 is provided with a third connecting rod 46, the third connecting rod 46 is equipped with a first sliding plate 47 in contact with the outer casing 41. The first sliding plate 47 makes the first magnet 73 more stable during movement by limiting it via the first sliding plate 47. The third connecting rod 46 is provided with a second permanent magnet 48 at one end near the first permanent magnet 42, the second permanent magnet 48 and the first permanent magnet 42 have the same magnetic poles at one end close to each other.

Specifically, one end of the first magnet 73 away from the third connecting rod 46 is provided with a second connecting rod 44, the second connecting rod 44 protrudes beyond the outer casing 41. Meanwhile, one end of the second connecting rod 44 away from the first permanent magnet 42 is rotatably provided with a roller 45. The side wall of the cam disc 33 is in contact with the corresponding roller 45, making the movement between the cam disc 33 and the second connecting rod 44 more smoother. By reducing friction, it makes electric power generation of the device more labor-saving.

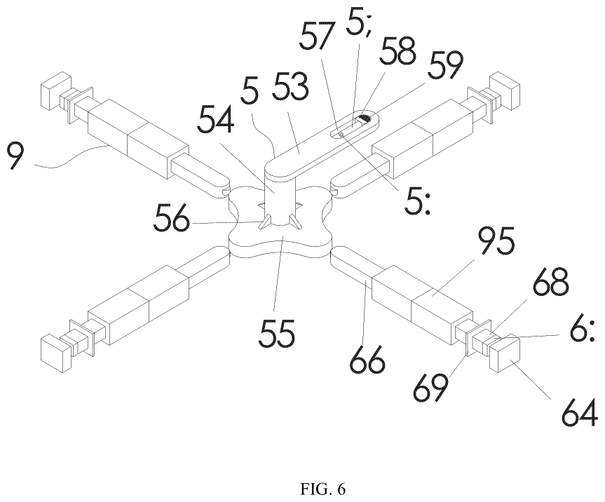

As shown in FIG. 6 and FIG. 9, the mobile intelligent terminal further includes a driving assembly 3 arranged on the phone shell 21, the driving assembly 3 includes a cam disc 33 rotatably arranged on the phone shell 21, a first connecting rod 32 arranged on the cam disc 33, a fixed block 34 connecting the first connecting rod 32 and the cam disc 33, the cam disc 33 abuts against one end of the second connecting rod 44 protruding from the outer casing 41.

As shown in FIG. 7 and FIG. 9, the driving assembly 3 further includes a first plate 31 connecting with the cam disc 33, the cam disc 33 is located within the phone shell 21, the first plate is located outside the phone shell 21. The phone shell 21 is provided with a first groove 22, and the first plate 31 is rotatably arranged in the first groove 22.

Specifically, the cam disc 33 is in an “X” shape, it is designed to push the second connecting rod 44 move back and forth via the roller 45, making the first magnet 73 to move in a periodic manner effectively, thereby the electric power generation is more stable.

As shown in FIG. 7 and FIG. 9, there are a plurality of the emergency power generating assemblies 7, the pluralities of the emergency power generating assembly 7 are arranged surrounding the cam disc 33 to be used in conjunction with the cam disc 33. The cam disc 33 rotates to make the first magnet 73 move, the cam disc 33 is then rebounded by the repulsive force between the first permanent magnet 42 and the second permanent magnet 48, thereby achieving the reciprocating movement.

Specifically, the second connecting rod 44 drives the first magnet 73 to reciprocate by rotating the driving assembly 3, making the first magnet 73 to move relative to the induction coil 78, so that the induction coil 78 cuts the magnetic induction lines of the first magnet 73, generating electromotive force to achieve energy conversion and transmission. It is used for temporary calls and location service when there is no power bank or external power supply, making it convenient and practical.

Specifically, the driving assembly 3 further includes a retaining rod 38 arranged inside the first plate 31, a rotating sleeve 39 rotatably arranged on the retaining rod 38. The first plate 31 is recessed with a second groove 35 for accommodating the retaining rod 38. One end of the retaining rod 38 away from the first connecting rod 32 is fixedly connected to a block member 36, the block member 36 is arranged inside the second groove 35 and rotatably connected to the first plate 31. The block member 36 is provided with an anti-skid block 37, the anti-skid block 37 is used to lift the retaining rod 38 when the anti-skid block 37 is pressed. By rotating the rotating sleeve 39, the user charges the smartphone 1 via the first charging coil 23 and the second charging coil 66. It is convenient to use and easy to fold the retaining rod 38 after use, which is beneficial for storing the phone shell 21 if not being used.

Specifically, the outer casing 41, the housing 51, the cylindrical body 71, and the second plate 76 are all made of magnetism shielding materials, such as ferrite or magnetic metal materials. Ferrite is an electromagnetic material with good magnetic conductivity. It is able to absorb and disperse magnetic field lines, thereby blocking the spreading of magnetic fields. Ferrite materials are commonly used as magnetic shielding covers, magnetic absorption materials, etc, avoiding electromagnetic interference on electronic devices and systems, thereby improving the stability of the smartphone 1.

The present invention further generates electricity to charge the smartphone 1 for emergency use, by shaking the smartphone 1 to move the first magnet 73, rotating the driving assembly 3 on the phone case 2, and pressing the press component 6 on the smartphone 1.

The above embodiments, which are intended to enable those skilled in the art to understand the content of the disclosure and implement it accordingly, are merely for describing the technical concepts and features of the disclosure, and the scope of patent application of the disclosure cannot be defined only by the embodiments, i.e., any equivalent variations or modifications made in accordance with the spirit disclosed by the disclosure still fall within the scope of claims of the disclosure.

What is claimed is:

1. A mobile intelligent terminal with emergency charging function, comprising:
a smartphone;
an emergency power generating assembly cooperating with the smartphone;
the emergency power generating assembly includes an induction coil and a first magnet, the first magnet reciprocates relative to the induction coil, the first magnet moves relative to the induction coil, making the induction coil to cut the magnetic induction lines of the first magnet, the induction coil is used to charge a lithium battery of the smartphone.

2. The mobile intelligent terminal as defined in claim 1, wherein the emergency power generating assembly further includes a cylindrical body, two second magnets and a first rod, two second magnets are arranged on the cylindrical body, two first rods are arranged on two ends of the first magnet, a third magnet is arranged at one end of two first rods away from each other, the third magnet is located between two second magnets, the third magnet and one end of two second magnets close to each other have the same magnetic poles; the induction coil is arranged on the cylindrical body and surrounds the first magnet, the first magnet is reciprocally arranged within the cylindrical body.

3. The mobile intelligent terminal as defined in claim 2, wherein the emergency power generating assembly further includes two second plates arranged on the cylindrical body, two second plates are both located between two third magnets, the second plate is provided with a bored hole penetrating through the second plate, the second plate is provided with a rolling element for rolling, there are at least three rolling elements arranged surrounding the first rod, the first rod and the second plate is movably arranged via the rolling element.

4. The mobile intelligent terminal as defined in claim 3, wherein the distance between the first magnet and the second plate is larger than the distance between the third magnet and the second magnet.

5. The mobile intelligent terminal as defined in claim 1, wherein further includes a phone shell detachably connected to the smartphone, the emergency power generating assembly is defined on the phone shell, the smartphone is provided with a second charging coil in conjunction with the induction coil, the induction coil is used to charge the lithium battery of the smartphone via the second charging coil.

6. The mobile intelligent terminal as defined in claim 1, wherein the emergency power generating assembly further includes an outer casing and a first permanent magnet, the outer casing is defined on the smartphone or the phone shell, the first permanent magnet is defined on the outer casing, the induction coil is located in the outer casing, the first magnet reciprocates within the outer casing, the induction coil surrounds the first magnet, the first magnet is provided with a third connecting rod, the third connecting rod is provided with a second permanent magnet at one end near the first permanent magnet, the second permanent magnet and the first permanent magnet have the same magnetic poles at one end close to each other.

7. The mobile intelligent terminal as defined in claim 6, wherein one end of the first magnet away from the third connecting rod and is provided with a second connecting rod, the second connecting rod protrudes beyond the outer casing to facilitate a user's finger pressing.

8. The mobile intelligent terminal as defined in claim 7, wherein further includes a driving assembly arranged on the phone shell, the driving assembly includes a cam disc rotatably arranged on the phone shell, the cam disc abuts against one end of the second connecting rod protruding from the outer casing.

9. The mobile intelligent terminal as defined in claim 8, wherein the driving assembly includes a first plate connecting with the cam disc, the cam disc is located within the phone shell, the first plate is located outside the phone shell.

10. The mobile intelligent terminal as defined in claim 8, wherein there are a pluralities of the emergency power generating assemblies, the pluralities of the emergency power generating assembly are arranged surrounding the cam disc.
